(19) United States
(12) Patent Application Publication
(10) Pub. No.: US 2026/0141061 A1
(43) Pub. Date: May 21, 2026

(54) METHOD AND ELECTRONIC DEVICE FOR HANDLING ANOMALY DETECTION

(71) Applicant: RAPTORXAI PRIVATE LIMITED, Tellapur (IN)

(72) Inventor: Pratyusha Vemuri Venkata, Tellapur (IN)

(21) Appl. No.: 19/119,735

(22) PCT Filed: Dec. 12, 2024
(86) PCT No.: PCT/IN2024/052373

§ 371 Date: Apr. 9, 2025

(30) Foreign Application Priority Data
Dec. 13, 2023 (IN) 202341085188

(51) Int. Cl. G06F 21/55; G06F 21/56

(52) U.S. Cl. CPC G06F 21/554; G06F 21/566

(57) ABSTRACT

The present disclosure provides an electronic device (100) for handling an anomaly detection. The electronic device includes a data integration engine (120) obtaining a user-specific data from a plurality of sources. Further, the electronic device includes an LLM engine (125) utilizing an LLM technique and a natural language processing framework to process and analyse textual interactions included in the user-specific data. The LLM technique extracts linguistic cues and patterns from the user-specific data and creates a behavioural biometrics profile for each user from a plurality of users. Further, electronic device includes a contextual understanding engine (130) providing contextual understanding of user behaviour by considering semantics and sentiment of textual interactions and voice data included in the user-specific data using LLM technique. Further, the electronic device includes an anomaly detection engine (135) triggering anomaly detection using LLM technique by comparing the user behaviour with the collected user-specific data.

### TECHNICAL FIELD

The present disclosure relates to an anomaly detection method and system, and more specifically relates to a method and an electronic device for handling an anomaly detection.

### BACKGROUND

Conventional fraud prevention systems often rely on static rules or predefined patterns, which may not effectively adapt to evolving fraud techniques. Although machine learning-based approaches offer greater adaptability, they may face challenges in capturing the subtleties of user behaviour, particularly in complex textual interactions.

Various existing methods and systems are used for analysing an individual's voice to verify their identity using a voice biometrics technique. Some of the prior art references are given below for handling the voice biometrics technique.

US20210125619A1 discloses methods of authenticating a user or speaker. The methods include obtaining an input speech signal and user credentials identifying the user or speaker. The input speech signal includes a single-channel signal or a multi-channel speech signal. The methods further include extracting a speech voiceprint from the input speech signal, and retrieving a reference voiceprint associated to the user credentials. The methods still further include determining a voiceprint correspondence between the speech voiceprint and the reference voiceprint, and authenticating the user or speaker depending on said voiceprint correspondence. The methods yet further include updating the reference voiceprint depending on the speech voiceprint corresponding to the authenticated user or speaker.

US10325601B2 discloses methods and apparatuses for use in, for example, a call centre to identify speakers (e.g., an agent and caller) in a recorded or live conversation and to associate the identified speaker with their respective conversation portions.

Therefore, there is a need for an enhanced method and a fraud prevention system that excels in anomaly detection.

### OBJECT OF THE DISCLOSURE

A principal object of the present disclosure is to provide a method and an electronic device for handling an anomaly detection.

Another object of the present disclosure is to obtain a user-specific data from a plurality of sources for a plurality of users.

Yet another object of the present disclosure is to utilize a language Model-based Learning (LLM) technique and a natural language processing framework to process and analyse textual interactions included in the obtained user-specific data. The LLM technique extracts linguistic cues and patterns from the obtained user-specific data and creates a behavioural biometrics profile for each user from the plurality of users.

Yet another object of the present disclosure is to provide a contextual understanding of user behaviour by considering semantics and sentiment of textual interactions and voice data included in the obtained user-specific data using the LLM technique.

Yet another object of the present disclosure is to trigger anomaly detection using the LLM technique by comparing the user behaviour with the collected user-specific data.

Yet another object of the present disclosure is to perform cross-channel analysis by correlating the obtained user-specific data from different sources, wherein the cross-channel analysis enables the electronic device to identify patterns and inconsistencies that indicate a fraud activity from an attacker.

Yet another object of the present disclosure is to continuously learn new user-specific data from the plurality of sources, so as to allow the electronic device to adapt to determine fraud techniques and emerging threats by using the LLM technique.

Yet another object of the present disclosure is to establish a comprehensive behavioural biometrics framework for anomaly detection by leveraging the power of the LLM and integrating diverse data sources.

### SUMMARY

Accordingly, the present disclosure provides an electronic device for handling an anomaly detection. The electronic device includes a data integration engine configured to obtain a user-specific data from a plurality of sources for a plurality of users. Further, the electronic device includes a language Model-based Learning (LLM) engine configured to utilize an LLM technique and a natural language processing framework to process and analyse textual interactions included in the obtained user-specific data. The LLM technique extracts linguistic cues and patterns from the obtained user-specific data and creates a behavioural biometrics profile for each user from the plurality of users. Further, the electronic device includes a contextual understanding engine configured to provide a contextual understanding of user behaviour by considering semantics and sentiment of textual interactions and voice data included in the obtained user-specific data using the LLM technique. Further, the electronic device includes an anomaly detection engine configured to trigger anomaly detection using the LLM technique by comparing the user behaviour with the collect user-specific data.

In an embodiment, further, the electronic device includes a cross-channel analysis engine configured to perform cross-channel analysis by correlating the obtained user-specific data from different sources. The cross-channel analysis enables the electronic device to identify patterns and inconsistencies that indicate a fraud activity from an attacker. Further, the electronic device includes a continuous anomaly detection adaptation engine configured to continuously learn new user-specific data from the plurality of sources, so as to allow the electronic device to adapt to determine fraud techniques and emerging threats by using the LLM technique.

In an embodiment, the plurality of sources comprise a chat logs, email, device type, operating system, Global Positioning System (GPS) coordinates, internet protocol (IP) addresses, connection history, voice patterns, voice sentiment and fingerprint scans, and facial recognition.

In an embodiment, the user-specific data comprises textual interactions, device metadata, geolocation data, network behaviour, voice data and biometric data.

Accordingly, the present disclosure provides a method for handling an anomaly detection. The method includes obtaining, by a data integration engine of an electronic device, a user-specific data from a plurality of sources for a plurality of users. Further, the method includes utilizing, by an LLM engine of the electronic device, an LLM technique and a natural language processing framework to process and analyse textual interactions included in the obtained user-specific data. The LLM technique extracts linguistic cues and patterns from the obtained user-specific data and creates a behavioural biometrics profile for each user from the plurality of users. Further, the method includes providing, by a contextual understanding engine of the electronic device, a contextual understanding of user behaviour by considering semantics and sentiment of textual interactions and voice data included in the obtained user-specific data using the LLM technique. Further, the method includes triggering, by an anomaly detection engine of the electronic device, anomaly detection using the LLM technique by comparing the user behaviour with the collect user-specific data.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIG. 1 shows various hardware components of an electronic device.

FIG. 2 is a flow chart illustrating a method for handling an anomaly detection.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The present disclosure provides an electronic device for handling an anomaly detection. The electronic device includes a data integration engine configured to obtain a user-specific data from a plurality of sources for a plurality of users. Further, the electronic device includes an LLM engine configured to utilize an LLM technique and a natural language processing framework to process and analyse textual interactions included in the obtained user-specific data. The LLM technique extracts linguistic cues and patterns from the obtained user-specific data and creates a behavioural biometrics profile for each user from the plurality of users. Further, the electronic device includes a contextual understanding engine configured to provide a contextual understanding of user behaviour by considering semantics and sentiment of textual interactions and voice data included in the obtained user-specific data using the LLM technique. Further, the electronic device includes an anomaly detection engine configured to trigger anomaly detection using the LLM technique by comparing the user behaviour with the collect user-specific data.

In existing methods, a voice biometrics technique analyses an individual's voice to verify their identity. This approach emphasizes unique vocal characteristics such as pitch, tone, rhythm, and accent. The primary purpose of the voice biometrics technique is identity verification and authentication, focusing less on understanding content and more on confirming the speaker's identity. The voice biometrics technique relies on the consistency of voice patterns over time. The voice biometrics technique is effective in detecting imposters but may not be as effective in understanding the context or intent behind spoken words. In another existing methods, a speech analysis technique uses audio processing techniques to capture and analyse voiceprints. The speech analysis technique involves sophisticated algorithms that can detect even minor variations in voice, which are unique to each individual.

The LLM analyses text for linguistic and contextual cues, whereas the voice biometrics technique focuses on analysing voice patterns for identity verification. The LLM aims to detect fraud by understanding language and context, while the voice biometrics primarily aims to authenticate identity. The LLM is rooted in Natural Language Processing (NLP) and machine learning, focusing on text analysis. In contrast, voice biometrics is based on audio processing and voiceprint analysis. The LLM can adapt to different types of fraud based on language use, while the voice biometrics is more focused on the consistent physiological aspect of a person's voice.

The LLM primarily analyses the textual data and focuses on the content, context, and nuances of language used in communications. This includes emails, chat messages, documents, and even transcribed voice data. The LLM uses sophisticated Natural Language Processing (NLP) techniques to understand and interpret human language. The LLM can detect subtle linguistic cues that may indicate fraudulent behaviour, such as inconsistencies in communication, unnatural language patterns, or indications of deception. The LLM is adept at understanding context and can analyse conversations or text for hidden meanings, sentiment, and intent. This ability is crucial in identifying sophisticated fraud schemes where contextual understanding is key. The LLM continuously learns from new data, adapting to evolving language use and new fraud tactics. They can be trained on specific types of fraud and are highly adaptable to different industries and use cases. The LLM-based fraud detection is integrated with the electronic device that handle textual data, such as email servers, chat platforms, or document management systems.

Unlike existing methods and systems, the electronic device provides advanced behavioral biometrics utilizing LLM. The electronic device collects and integrates a wide range of user-specific data sources, including but not limited to, textual interactions, device metadata, geolocation, network behavior, voice, and biometric data. The LLM is employed to analyze and interpret the integrated data for the purpose of detecting and preventing fraud across various industries, including e-commerce, finance, healthcare, and telecommunications. The proposed electronic device leverages LLM's unique capabilities to provide a contextual understanding of user behavior, detect anomalies, perform cross-channel analysis, and continuously adapt to evolving threats.

Advantageously, the electronic device provides more accurate fraud detection by analyzing linguistic nuances and voice patterns by using the LLM's contextual understanding of the user behavior, especially in textual interactions and voice data. The electronic device being able to establish the user behavior baselines and detect anomalies enhances its fraud prevention capabilities, even in scenarios where fraud attempts exhibit subtle deviations. The electronic device utilizes the LLM and diverse data sources to enhance fraud detection and prevention in a more accurate manner.

In an example, consider a scenario for a voice-based authentication in the banking system, where a customer uses voice commands to access banking services through their mobile devices (e.g., smart phone or the like) or banking applications running in the mobile devices. The LLM (through the Language Model-based Learning (LLM) engine ) analyses the customer's voice patterns during interactions. The LLM understands not only the content of what is being said but also how it's being said such as tone, pitch, and other nuances. The mobile device establishes a baseline of the customer's typical voice patterns and uses this for future comparisons. If a fraudster attempts to access the account using voice commands, the LLM detects anomalies in voice patterns compared to the established baseline, even if the content of the speech is similar. Subtle deviations in tone, speed, or accent that might not be immediately apparent to human listeners are flagged by the LLM. Further, the LLM triggers additional security checks or alerts.

In another example, consider a scenario for customer support chat interactions, where the customers engage with customer support through text-based chat on a bank's website or bank's application. By using the proposed method, the LLM evaluates the language, style, and pattern of the customer's text messages. The LLM builds a linguistic profile based on their historical interactions. The electronic device looks for nuances like sentence structure, use of specific terminologies, and overall communication style. If the fraudster, impersonating the customer, starts a chat with a customer support, the LLM detects discrepancies in the linguistic style compared to the established customer profile. Even if the fraudster provides correct account details, the LLM triggers fraud alerts by using inconsistencies in their typing style, language use, or phraseology.

In another example, consider a scenario for behavioural analysis in a mobile banking application usage, where the customers use the mobile banking application for transactions, account management, and communication with the bank. The LLM, integrated into the application, analyses not only the textual content entered by the user but also interprets the context of their interactions like querying about unusual transactions or expressing concern about account security. The electronic device establishes normal patterns of user interactions, including the types of queries made and the typical tone or urgency in their communications. In a situation where a user's account is compromised, and the fraudster starts making transactions or inquiries, the LLM picks up on typical patterns in the textual interactions. Changes in the way questions are phrased, sudden urgency, or different types of queries than usual can all be indicators of fraud, so that the electronic device prompts to take precautionary measures such as temporary account locks or verification callbacks. In each of these scenarios, the LLM's ability to understand and analyse linguistic nuances and voice patterns plays a crucial role in enhancing fraud detection. By establishing behavioural baselines and detecting even subtle deviations, the electronic device with LLM capabilities offers a sophisticated, nuanced approach to fraud prevention, significantly increasing the accuracy and reliability of security measures in digital banking contexts.

In yet another example, consider a scenario for analysis of email communications for loan applications, where the customers apply for loans via email, provide personal and financial information, and often engage in follow-up correspondence. Based on the proposed method, the LLM analyses the content, style, and linguistic patterns of emails sent by the customers during the loan application process. The LLM establishes a linguistic profile for each applicant based on their email interactions. The LLM is trained to recognize specific patterns and red flags often associated with fraudulent loan applications, such as inconsistencies in financial details, urgency in communication, or deviations from standard language used in legitimate applications. If the fraudster attempts to apply for a loan using stolen or fabricated information, the LLM detects discrepancies in language or patterns that don't align with typical applicant profiles. The electronic device triggers an in-depth review of the application by using the unusual phrasing, a typical urgency, or inconsistencies across multiple emails (especially when compared to known fraud cases).

In yet another example, consider a scenario for real-time monitoring of customer calls, where the customers interact with banking representatives through voice calls for various services and inquiries. The LLM is integrated into the call centre's software to analyse customer calls in real-time. It listens not only for the content of the conversation but also for vocal characteristics, stress levels, and other nuances in the customer's voice. The LLM builds a vocal profile for each customer based on historical call data, capturing their typical tone, speech patterns, and typical topics of inquiry or concern. In situations where a customer's account might be compromised, and the fraudster tries to gain information or perform transactions over the phone, the LLM detects anomalies in the voice pattern, stress levels, or conversation topics. Variations from the established vocal profile, such as differences in pitch or unusual hesitations, especially in responses to security questions or during high-risk transactions, the LLM alerts the electronic device to potential fraud, leading to immediate security protocols like call escalation or transaction holds.

Further, a cross-channel analysis provides a comprehensive view of user activity, enables the detection of patterns and inconsistencies across various data sources. The LLM's continuous learning ensures that the electronic device remains effective in identifying evolving fraud patterns and emerging threats.

The proposed method can be applied across various industries, including e-commerce, finance, healthcare, telecommunications, and more, to detect and prevent fraud effectively.

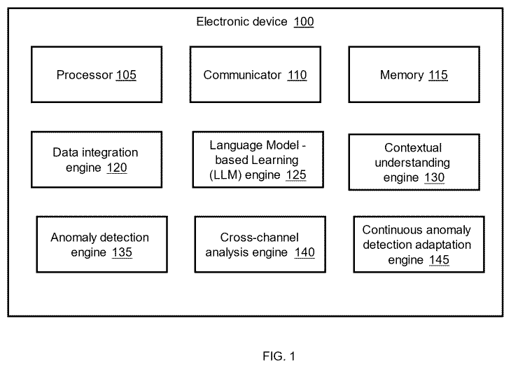

FIG. 1 shows various hardware components of an electronic device (100). The electronic device (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, a server, and an internet of things (IoT) device. In an embodiment, the electronic device (100) includes a processor (105), a communicator (110), a memory (115), a data integration engine (120), an LLM engine (125), a contextual understanding engine (130), an anomaly detection engine (135), a cross-channel analysis engine (140) and a continuous anomaly detection adaptation engine (145). The processor (105) is coupled with the communicator (110), the memory (115), the data integration engine (120), the LLM engine (125), the contextual understanding engine (130), the anomaly detection engine (135), the cross-channel analysis engine (140) and the continuous anomaly detection adaptation engine (145).

The data integration engine (120) collects user-specific data from multiple sources, such as textual interactions (e.g., chat logs, emails), device metadata (e.g., device type, operating system), geolocation data (e.g., GPS coordinates), network behavior (e.g., IP addresses, connection history), voice data (e.g., voice patterns, sentiment), and biometric data (e.g., fingerprint scans, facial recognition). Further, the LLM engine (125) utilizes LLM and a natural language processing framework to process and analyze textual interactions included in the user-specific data. The LLM extracts linguistic cues and patterns from the textual data and creates a behavioral biometrics profile for each user.

By using the LLM, the contextual understanding engine (130) provides a contextual understanding of user behavior by considering the semantics and sentiment of textual interactions and voice data. This enhances the ability of the electronic device (100) to differentiate between legitimate and fraudulent actions. Further, the anomaly detection engine (135) uses the LLM to establish the baseline of typical user behavior based on integrated data. Any deviations or anomalies from this baseline trigger alerts for further investigation.

Further, the cross-channel analysis engine (140) performs cross-channel analysis by correlating data from different sources (textual, device, geolocation, voice, etc.). This holistic view enables the electronic device (100) to identify patterns and inconsistencies that may indicate fraud. By using the LLM, the continuous anomaly detection adaptation engine (145) continuously learns from new data, allowing the electronic device (100) to adapt to evolving fraud techniques and emerging threats. This adaptive capability enhances long-term fraud prevention effectiveness.

In an example, the electronic device (100) can identify fraudulent transactions by analysing user behaviour during payment processes, considering the textual interactions, the device data, the geolocation, the voice, and the biometrics. By monitoring the user interactions and the behaviour patterns during refund requests, the electronic device (100) can detect refund abuse scenarios, so as to prevent the financial losses for e-commerce platforms. The electronic device (100) can flag suspicious seller behaviour by analysing the textual communications, transaction history, the geolocation data, the voice, and the biometrics, so as to protect online marketplaces from fraudulent sellers.

For example, in the healthcare industry, the electronic device (100) can detect medical identity theft by analysing patient interactions, the voice data, the device information, and the biometrics, so as to safeguard patient information and prevent the financial losses. In the telecommunications sector, the electronic device (100) can prevent telecom fraud by analysing call patterns, the textual interactions, the voice data, the geolocation, and the device metadata, so as to save the telecom providers from revenue losses.

The incorporation of LLM and diverse data sources is expected to increase the accuracy of fraud detection compared to traditional rules-based systems. This improvement stems from the LLM's ability to identify subtle behavioural cues and its continuous adaptation to emerging fraud.

Further, the contextual understanding allows for more accurate fraud detection, especially in scenarios where fraud attempts exhibit subtle deviations from typical behaviour. Further, the electronic device (100) being able to continuously adapt to evolving fraud techniques and emerging threats adds another layer of innovation, so as to ensure its effectiveness in the long term.

The data integration engine (120), the LLM engine (125), the contextual understanding engine (130), the anomaly detection engine (135), the cross-channel analysis engine (140) and the continuous anomaly detection adaptation engine (145) may implement analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (105) is configured to execute instructions stored in the memory (115) and to perform various processes relevant to the present disclosure. The communicator (110) is configured for communicating internally between internal hardware components and with external devices via one or more networks. Further, the memory (115) stores the fraudulent actions, the user-specific data, the textual interactions, and the behavioral biometrics profile. The memory (115) also stores instructions to be executed by the processor (105). The memory (115) may include non-volatile storage elements. Examples of such non-volatile storage elements may include magnetic hard disks, optical discs, floppy discs, flash memories, or forms of electrically programmable memories (EPROM) or electrically erasable and programmable (EEPROM) memories. In addition, the memory (115) may, in some examples, be considered a non-transitory storage medium. The term “non-transitory” may indicate that the storage medium is not embodied in a carrier wave or a propagated signal. However, the term “non-transitory” should not be interpreted that the memory (115) is non-movable. In certain examples, a non-transitory storage medium may store data that can, over time, change (e.g., in Random Access Memory (RAM) or cache).

Although FIG. 1 shows various hardware components of the electronic device (100) but it is to be understood that other embodiments are not limited thereon. In other embodiments, the electronic device (100) may include less or more number of components. Further, the labels or names of the components are used only for illustrative purposes and do not limit the scope of the invention. One or more components can be combined together to perform the same or substantially similar function in the electronic device (100).

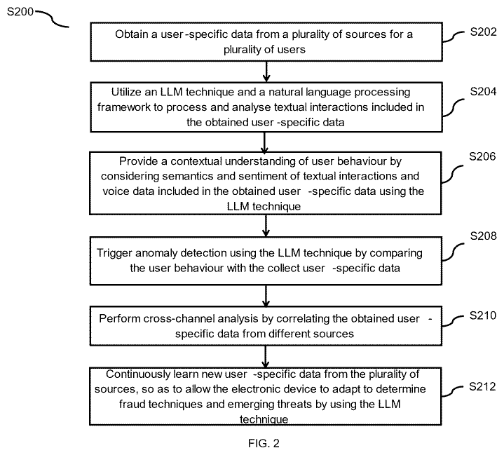

FIG. 2 is a flow chart (S200) illustrating a method for handling the anomaly detection.

At S202, the method includes obtaining the user-specific data from the plurality of sources for the plurality of users. In an embodiment, the method allows the data integration engine (120) to obtain the user-specific data from the plurality of sources for the plurality of users.

At S204, the method includes utilizing the LLM technique and the natural language processing framework to process and analyse the textual interactions included in the obtained user-specific data. In an embodiment, the method allows the LLM engine (125) to utilize the LLM technique and the natural language processing framework to process and analyse textual interactions included in the obtained user-specific data. The LLM technique extracts linguistic cues and patterns from the obtained user-specific data and creates the behavioural biometrics profile for each user from the plurality of users.

At S206, the method includes providing the contextual understanding of user behaviour by considering semantics and sentiment of textual interactions and the voice data included in the obtained user-specific data using the LLM technique. In an embodiment, the method allows the contextual understanding engine (130) to provide the contextual understanding of user behaviour by considering semantics and sentiment of textual interactions and voice data included in the obtained user-specific data using the LLM technique.

At S208, the method includes triggering the anomaly detection using the LLM technique by comparing the user behaviour with the collect user-specific data. In an embodiment, the method allows the anomaly detection engine (135) to trigger anomaly detection using the LLM technique by comparing the user behaviour with the collect user-specific data.

At S210, the method includes performing the cross-channel analysis by correlating the obtained user-specific data from different sources. In an embodiment, the method allows the cross-channel analysis engine (140) to perform cross-channel analysis by correlating the obtained user-specific data from different sources. The cross-channel analysis enables the electronic device (100) to identify patterns and inconsistencies that indicate the fraud activity from the attacker.

At S212, the method includes continuously learning the new user-specific data from the plurality of sources, so as to allow the electronic device (100) to adapt to determine fraud techniques and emerging threats by using the LLM technique. In an embodiment, the method allows the continuous anomaly detection adaptation engine (145) to continuously learn new user-specific data from the plurality of sources, so as to allow the electronic device (100) to adapt to determine fraud techniques and emerging threats by using the LLM technique.

The various actions, acts, blocks, steps, or the like in the flow chart (S200) may be performed in the order presented, in a different order or simultaneously. Further, in some implementations, some of the actions, acts, blocks, steps, or the like may be omitted, added, modified, skipped, or the like without departing from the scope of the invention.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid-state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain alternative include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

What is claimed is:

1. An electronic device (100) for handling
an anomaly detection, comprising: a processor;
a memory; and
a data integration engine, coupled to the processor and the memory, configured to obtain a user-specific data from a plurality of sources for a plurality of users;
a language Model-based Learning (LLM) engine, coupled to the processor and the memory, configured to utilize an LLM technique and a natural language processing framework to process and analyse textual interactions included in the obtained user-specific data, wherein the LLM technique extracts linguistic cues and patterns from the obtained user-specific data and creates a behavioural biometrics profile for each user from the plurality of users;
a contextual understanding engine, coupled to the processor and the memory, configured to provide a contextual understanding of user behaviour by considering semantics and sentiment of textual interactions and voice data included in the obtained user-specific data using the LLM technique; and
an anomaly detection engine, coupled to the processor and the memory, configured to trigger anomaly detection using the LLM technique by comparing the user behaviour with the collect user-specific data.

2. The electronic device as claimed in claim 1, wherein the electronic device comprising:
a cross-channel analysis engine, coupled to the processor and the memory, configured to perform cross-channel analysis by correlating the obtained user-specific data from different sources, wherein the cross-channel analysis enables the electronic device to identify patterns and inconsistencies that indicate a fraud activity from an attacker; and
a continuous anomaly detection adaptation engine, coupled to the processor and the memory, configured to continuously learn new user-specific data from the plurality of sources, so as to allow the electronic device to adapt to determine fraud techniques and emerging threats by using the LLM technique.

3. The electronic device as claimed in claim 1, wherein the plurality of sources comprises chat logs, email, device type, operating system, Global Positioning System (GPS) coordinates, internet protocol (IP) addresses, connection history, voice patterns, voice sentiment and fingerprint scans, and facial recognition.

4. The electronic device as claimed in claim 1, wherein the user-specific data comprises textual interactions, device metadata, geolocation data, network behaviour, voice data and biometric data.

5. A method for handling an anomaly detection, comprising:
obtaining, by a data integration engine of an electronic device, a user-specific data from a plurality of sources for a plurality of users;
utilizing, by a language Model-based Learning (LLM) engine of the electronic device, an LLM technique and a natural language processing framework to process and analyse textual interactions included in the obtained user-specific data, wherein the LLM technique extracts linguistic cues and patterns from the obtained user-specific data and creates a behavioural biometrics profile for each user from the plurality of users;
providing, by a contextual understanding engine of the electronic device, a contextual understanding of user behaviour by considering semantics and sentiment of textual interactions and voice data included in the obtained user-specific data using the LLM technique; and
triggering, by an anomaly detection engine of the electronic device, anomaly detection using the LLM technique by comparing the user behaviour with the collect user-specific data.

6. The method as claimed in claim 5, wherein the method comprises:
performing, by a cross-channel analysis engine of the electronic device, a cross-channel analysis by correlating the obtained user-specific data from different sources, wherein the cross-channel analysis enables the electronic device to identify patterns and inconsistencies that indicate a fraud activity from an attacker; and
continuously learning, by a continuous anomaly detection adaptation engine of the electronic device, new user-specific data from the plurality of sources, so as to allow the electronic device to adapt to determine fraud techniques and emerging threats by using the LLM technique.

7. The method as claimed in claim 5, wherein the plurality of sources comprises chat logs, email, device type, operating system, Global Positioning System (GPS) coordinates, internet protocol (IP) addresses, connection history, voice patterns, voice sentiment and fingerprint scans, and facial recognition.

8. The method as claimed in claim 5, wherein the user-specific data comprises textual interactions, device metadata, geolocation data, network behaviour, voice data and biometric data.
